(19) United States
(12) Patent Application Publication
(10) Pub. No.: US 2005/0110287 A1
(43) Pub. Date: May 26, 2005

(54) 200 MM notched/flatted wafer edge gripping end effector

(75) Inventors: Anthony Florindi, Norfolk, MA (US); Frederick A. Goodman, Brookline, MA (US)

Correspondence Address: WEINGARTEN, SCHURGIN, GAGNEBIN & LEBOVICI LLP, TEN POST OFFICE SQUARE, BOSTON, MA, 02109, US

(73) Assignee: ADE Corporation

(21) Appl. No.: 10/971,696

(22) Filed: Oct. 22, 2004

Related U.S. Application Data
(60) Provisional application No. 60/514,281, filed on Oct. 24, 2003.

(51) Int. Cl. B65G 1/133

(52) U.S. Cl. 294/2

(57) ABSTRACT

An improved apparatus for handling semiconductor wafers is provided. The semiconductor wafer handling apparatus includes a wafer edge gripping end effector having a paddle substrate with a distal end and a proximal end, a first arcuate wafer contact pad disposed on the substrate at the distal end, and second and third arcuate wafer contact pads disposed on the substrate adjacent the proximal end. Each one of the wafer contact pads includes a first arcuate surface and a second beveled surface for engaging an edge of a wafer. The end effector further includes a movable wafer gripping finger disposed on the substrate between the second and third wafer contact pads. The movable finger has a first arcuate surface for contacting the wafer edge, and for pushing the wafer edge against the first wafer contact pad, thereby securing the wafer on the substrate.

### CROSS REFERENCE TO RELATED APPLICATIONS

This application claims priority of U.S. Provisional Patent Application No. 60/514,281 filed Oct. 24, 2003 entitled 200 MM NOTCHED/FLATTED WAFER EDGE GRIPPING END EFFECTOR.

### STATEMENT REGARDING FEDERALLY SPONSORED RESEARCH OR DEVELOPMENT

N/A

### BACKGROUND OF THE INVENTION

The present application relates generally to the handling of semiconductor wafers, and more specifically to a wafer edge gripping end effector for loading and unloading a semiconductor wafer into and out of a process machine or a wafer cassette.

In the fabrication of integrated circuits (ICs), semiconductor wafers upon which the ICs are formed typically pass through numerous processing steps. For example, during each processing step, a semiconductor wafer may be transported into or out of a specific process machine and/or a wafer storage container commonly known as a wafer cassette. Further, between the various processing steps, a wafer may have its orientation changed, may be placed in a fixture, and/or may be transported to another process machine in a subsequent processing step. All of these wafer processing operations are generally performed in a clean room environment.

Conventional apparatus for handling semiconductor wafers may employ grippers configured to contact the backside of a wafer when transporting the wafer to a process machine or a wafer cassette. Such conventional wafer handling apparatus have drawbacks, however, because contacting the backside of the wafer may lead to unwanted wafer contamination. Conventional wafer handling apparatus may alternatively employ grippers configured to handle a wafer by the wafer's edge. Such conventional wafer edge gripping apparatus also have drawbacks, however, because they are often subject to sudden exertions of force and mechanism wear, which can lead to further wafer contamination. Moreover, conventional wafer handling apparatus frequently suffer from (1) wafer jams when inserting and/or removing wafers from a wafer cassette, (2) misalignment of wafers within the wafer cassette, and/or (3) contaminants deposited on wafers due to breakdowns of the transport mechanism.

In addition, semiconductor wafers generally include fiducial features such as wafer notches and flats, which are typically formed in the wafer's edge. However, such fiducial features often prevent conventional wafer edge gripping apparatus from handling wafers securely and/or from maintaining proper wafer orientation while transporting the wafers to and from process machines and wafer cassettes during IC fabrication.

It would therefore be desirable to have an improved apparatus for handling semiconductor wafers that avoids the drawbacks of the above-described conventional wafer handling apparatus.

### BRIEF SUMMARY OF THE INVENTION

In accordance with the present invention, an improved apparatus for handling semiconductor wafers is provided. In one embodiment, the semiconductor wafer handling apparatus comprises a wafer edge gripping end effector including a paddle substrate having a distal end and a proximal end, a first arcuate wafer contact pad disposed on the paddle substrate at the distal end, and second and third arcuate wafer contact pads disposed on the paddle substrate adjacent the proximal end. Each one of the first, second, and third wafer contact pads includes a first arcuate surface and a second beveled surface configured to engage a circumferential edge of a wafer. The end effector further includes a movable wafer gripping finger disposed on the paddle substrate between the second and third wafer contact pads adjacent the proximal end. The movable finger has a first arcuate surface configured to contact the edge of the wafer. The movable finger is operative to move toward the distal end of the paddle substrate, to contact the edge of the wafer by the first surface thereof, and to push the edge of the wafer against the first surface of the first wafer contact pad, thereby securing the wafer engaged by the first, second, and third wafer contact pads.

The wafer edge gripping end effector is operative to grip a wafer along its edge, to hold a wafer securely in a desired orientation regardless of the location of fiducial features such as wafer notches and flats formed in the wafer's edge, and to avoid interference with support structures typically included in standard wafer carriers and cassettes.

Other features, functions, and aspects of the invention will be evident from the Detailed Description of the Invention that follows.

### BRIEF DESCRIPTION OF THE SEVERAL VIEWS OF THE DRAWINGS

The invention will be more fully understood with reference to the following Detailed Description of the Invention in conjunction with the drawings of which:

FIG. 1 is a plan view of a semiconductor wafer edge gripping end effector according to the present invention;

FIG. 2a is a perspective view of the wafer edge gripping end effector of FIG. 1;

FIG. 2b is a cross-sectional view of a wafer contact pad at a distal end of the wafer edge gripping end effector of FIG. 1;

FIG. 2c is a cross-sectional view of a wafer contact pad at a proximal end of the wafer edge gripping end effector of FIG. 1;

FIG. 3a is a detailed view of the distal end of the wafer edge gripping end effector of FIG. 1;

FIG. 3b is a detailed view of the proximal end of the wafer edge gripping end effector of FIG. 1;

FIG. 4 is an illustration of the wafer edge gripping end effector of FIG. 1 loading/unloading a semiconductor wafer into/out of a wafer cassette;

FIGS. 5a-5d are illustrations of the wafer edge gripping end effector of FIG. 1 handling a wafer having a wafer flat in various wafer orientations;

FIG. 6 is a detailed view of the distal end of the wafer edge gripping end effector of FIG. 1 illustrating a scanning light beam for mapping wafers stored in a wafer cassette;

FIGS. 7-8 are illustrations of the wafer edge gripping end effector of FIG. 1 mapping a wafer having a wafer flat in various wafer orientations;

FIGS. 9a-9b are diagrams illustrating the operation of the wafer edge gripping end effector of FIG. 1 during wafer mapping;

FIGS. 10a-10b are perspective views of a linear actuator included in the wafer edge gripping end effector of FIG. 1; and

FIG. 10c is a cross-sectional view of the linear actuator of FIGS. 10a-10b.

### DETAILED DESCRIPTION OF THE INVENTION

U.S. Provisional Patent Application No. 60/514,281 filed Oct. 24, 2003 entitled 200 MM NOTCHED/FLATTED WAFER EDGE GRIPPING END EFFECTOR is incorporated herein by reference.

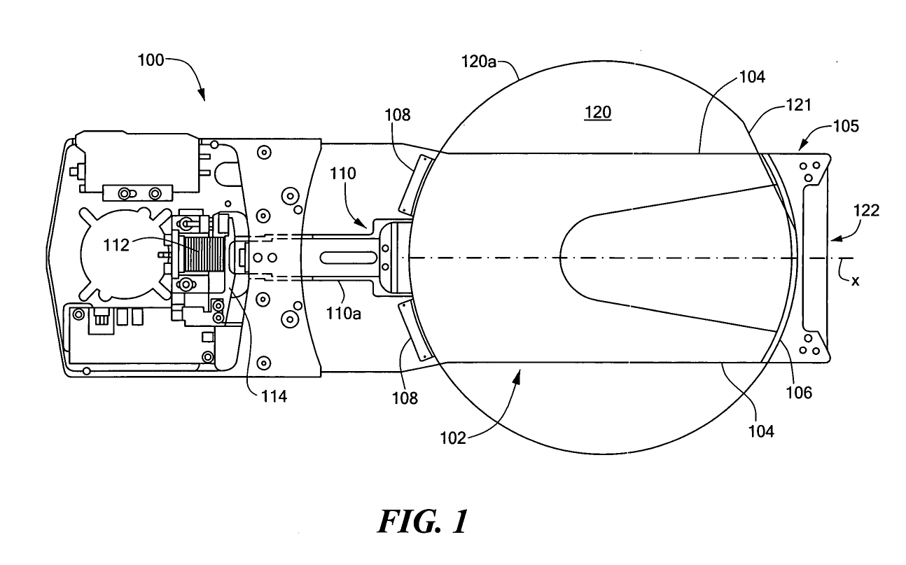

FIG. 1 depicts an illustrative embodiment of a wafer edge gripping end effector 100, in accordance with the present invention. In the illustrated embodiment, the wafer edge gripping end effector 100 includes a paddle substrate 102, a pair of fixed elongated fingers 104 formed in the paddle substrate 102, an arcuate wafer contact pad 105 at a distal end of the end effector 100, and a pair of identical arcuate wafer contact pads 108 and a movable arcuate wafer gripper finger 110 near a proximal end of the end effector 100. As indicated in FIG. 1, the end effector 100 is configured to pick up a semiconductor wafer 120 by contacting an edge 120a of the wafer 120. The end effector 100 is configured to hold the wafer 120 securely by its edge 120a in any desired orientation regardless of the location of fiducial features such as wafer notches and/or flats (e.g., a flat 121) formed in the wafer's edge.

Those of ordinary skill in this art will appreciate that the processing of semiconductor wafers during integrated circuit (IC) fabrication includes transporting a semiconductor wafer from a wafer cassette to various processing locations by a robotic handling system (not shown). The typical robotic handling system includes a mechanism having multiple degrees of freedom in at least the radial, angular, and vertical directions with an end effector attached to one end of a robot arm. For example, the proximal end of the wafer edge gripping end effector 100 opposite the wafer contact pad 10-5 may be operatively attached to the robot arm. The robotic handling system is operative to control the robot arm and the end effector, thereby allowing the robot arm and the end effector to, for example, pick up a semiconductor wafer from a wafer cassette for subsequent transport to a designated processing location where the wafer may undergo one of a variety of processing steps such as etching or chemical vapor deposition.

Those of ordinary skill in this art will further appreciate that a wafer cassette is a device typically molded of plastic material that may be used to store a large number of semiconductor wafers in a horizontal or vertical position. To maximize the number of wafers that can be stored in the wafer cassette, the wafers are typically positioned relatively close to each other within the cassette. For example, the pitch distance between the wafers may be about 0.220 inches in a standard 200 mm wafer cassette. When stored in the wafer cassette, the wafers are generally supported along their edges by molded-in support structures on the inner walls of the cassette. It is noted that the structure and operation of the robotic handling system and the wafer cassette are known to those skilled in this art and therefore need not be described in detail herein.

As described above, the wafer edge gripping end effector 100 is configured to handle the semiconductor wafer 120 by holding the wafer by the wafer's edge. To that end, the larger arcuate wafer contact pad 105 is disposed between the fingers 104 and attached to the ends of the fingers 104 using any suitable fasteners or adhesive. Further, the smaller wafer contact pads 108 are disposed on the surface of the substrate 102 and attached to the substrate surface using any suitable fasteners or adhesive. As shown in FIG. 1, the wafer contact pads 105 and 108 are curved to substantially match the contour of the edge 120a of the wafer 120. Like the wafer contact pads 105 and 108, the movable wafer gripper 110 disposed between the wafer contact pads 108 is also curved to substantially match the contour of the wafer's edge.

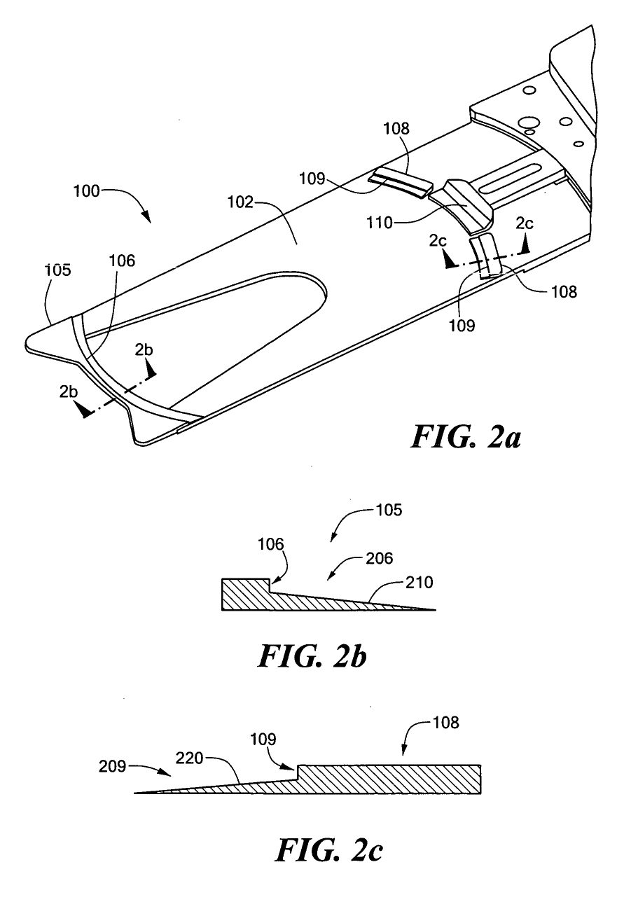

In the presently disclosed embodiment, the wafer contact pads 105 and 108 are configured to support the semiconductor wafer 120 in both a pre-gripped state and a post-gripped state. In the pre-gripped state, i.e., before the movable wafer-gripper finger 110 is actuated, the wafer gripper 110 provides sufficient clearance to allow the wafer contact pads 105 and 108 to surround the wafer 120 and to support the wafer 120 prior to pick up. In the post-gripped state, i.e., when the movable wafer gripper finger 110 is actuated, the wafer gripper 110 is operative to move along the axis X (see FIG. 1) toward the wafer contact pad 105 and to push the wafer's edge gently against a backstop 106 (see also FIGS. 2a-2b) of the wafer contact pad 105, thereby assuring secure clamping of the wafer 120 between the wafer gripper 110 and the wafer contact pad 105 along the wafer's edge. While the semiconductor wafer 120 is securely clamped by its edge in the post-gripped state, portions of the wafer's edge rest on the wafer contact pads 108.

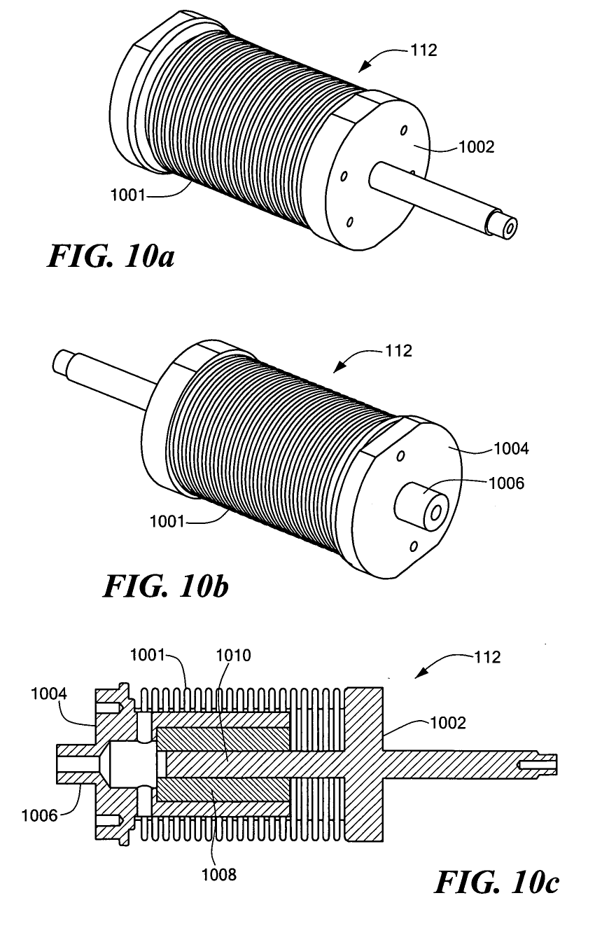

Specifically, the movable wafer gripper 110 is actuated by an effector mechanism including a linear actuator 112 and an arm 114. In the illustrated embodiment, the linear actuator 112 and the arm 114 are mounted within a sub-assembly attached to the proximal end of the paddle substrate 102. The linear actuator 112 includes a bellows, a sealed first end cap disposed against the arm 114, and a second end cap including a port. In a typical mode of operation, a vacuum is created within the linear actuator 112 via the port, thereby retracting the bellows. When the vacuum is released via the port, the bellows expands and the sealed end exerts a force on the arm 114, thereby causing the arm 114 to move in a linear fashion with the bellows and to push against an elongated portion 110a of the wafer gripper 110, which in turn gently pushes against the edge of the wafer 120 positioned between the wafer contact pads 105 and 108. When the vacuum is reestablished within the linear actuator 112, the bellows again retracts and the arm 114 returns to its initial position, thereby causing the wafer gripper 110 to move away from the wafer 120. It should be understood that the effector mechanism including the arm 114 is described herein for purposes of illustration, and that alternative structure for moving the wafer gripper 110 along the axis X may be employed. The linear actuator 112 is described in further detail below with reference to FIGS. 10a-10c.

In the presently disclosed embodiment, the wafer edge gripping end effector 100 is operative to sense the position of the movable wafer gripper 110. Specifically, the end effector 100 is operative to sense positions of the wafer gripper 110 along the axis X including a pre-actuated position, a first post-actuated position indicative of a properly gripped wafer, and a second post-actuated position indicative of an improperly gripped wafer. The pre-actuated position of the wafer gripper 110 corresponds to the above-described pre-gripped state of the end effector 100, and the first post-actuated position of the wafer gripper 110 corresponds to the above-described post-gripped state of the end effector 100. In the second post-actuated position, the wafer gripper 110 is typically moved toward the wafer contact pad 105 along the axis X to a position beyond what would normally be required for properly gripping a wafer. For example, the end effector 100 may sense the position of the movable wafer gripper finger 110 using an optical detector or any other suitable displacement sensing mechanism.

In the preferred embodiment, the height of the wafer edge gripping end effector 100 including the paddle substrate 102 and the wafer contact pads 105 and 108 and the wafer gripper 110 disposed thereon is small enough to allow the end effector 100 to pass safely between adjacent semiconductor wafers stored within a standard 200 mm wafer cassette. Further, the substrate 102 is preferably made of carbon fiber or any other suitable high-strength low-mass material. Moreover, the wafer contact pads 105 and 108 and the portion of the wafer gripper 110 contacting the wafer's edge are preferably made of poly ether ether ketone (PEEK) or any other suitable inert polymer or plastic material.

FIG. 2a depicts a perspective view of the wafer edge gripping end effector 100 including the paddle substrate 102, the wafer contact pads 105 and 108, and the wafer gripper 110. As shown in FIG. 2a, the arcuate wafer contact pad 105 includes the backstop 106. Similarly, the arcuate wafer contact pads 108 include respective backstops 109.

FIG. 2b depicts a cross-sectional view of the wafer contact pad 105. As shown in FIG. 2b, the wafer contact pad 105 comprises a wafer support structure 206 including the backstop 106 and a beveled portion 210. The beveled portion 210 of the support structure 206 is configured for slidably engaging a wafer while preventing the wafer contact pad 105 from contacting the flat surface (e.g., the backside) of the wafer. FIG. 2c depicts a cross-sectional view of one of the wafer contact pads 108. As shown in FIG. 2c, the wafer contact pad 108 comprises a wafer support structure 209 including the backstop 109 and a beveled portion 220. Like the beveled portion 210 of the wafer support structure 206, the beveled portion 220 is configured to engage a wafer while preventing the wafer contact pad 108 from contacting the flat surface (e.g., the backside) of the wafer resting on the support structure 209.

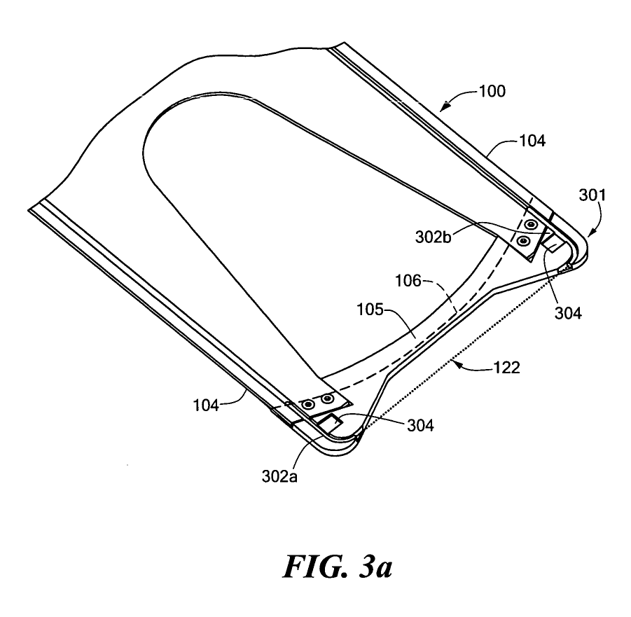

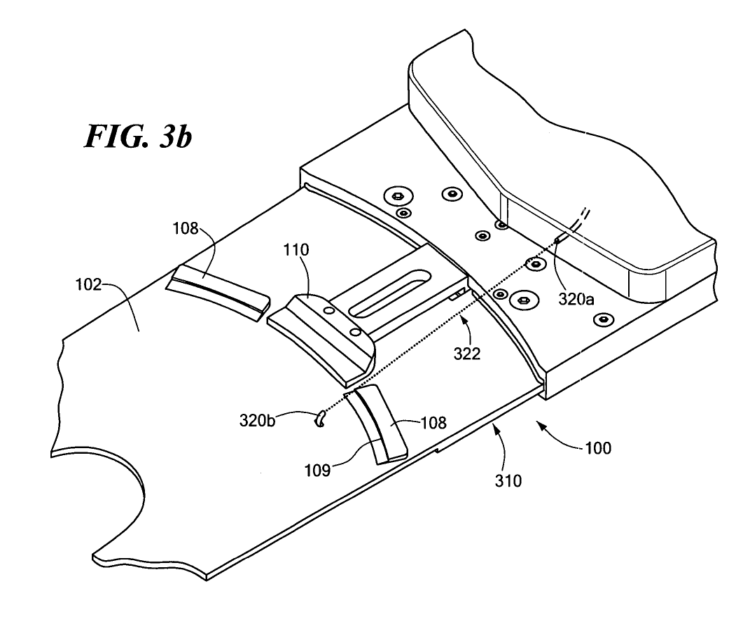

FIG. 3a depicts a detailed view of the distal end of the wafer edge gripping end effector 100. It is noted that FIGS. 2a and 3a depict opposite sides of the distal end of the end effector 100. As shown in FIG. 3a, the distal end of the end effector 100 includes a first through-beam type optical wafer scanner 301 including first and second optical fibers 302a-302b disposed in respective channels formed in the wafer contact pad 105 and the fingers 104. The first optical fiber 302a is configured to emit a light beam 122 (see also FIG. 1), and the second optical fiber 302b is configured to detect the light beam 122. It is noted that the respective positions of the optical fibers 302a-302b in the wafer contact pad 105 define a scanning chord distance 622 (see FIG. 6). Those of ordinary skill in this art will appreciate that optical components for generating and detecting the light beam 122 may be operatively coupled to the optical fibers 302a-302b. For example, such optical components may be housed in the sub-assembly disposed at the proximal end of the end effector 100. Each one of the optical fibers 302a-302b is positioned at a substantial right angle within the respective channel formed in the wafer contact pad 105. Further, fixing cleats 304 are employed to clamp the optical fibers 302a-302b within the respective channels. In the presently disclosed embodiment, the optical wafer scanner 301 including the emitter and detector fibers 302a-302b is operative to provide on-the-fly sensing of semiconductor wafers. Specifically, the optical wafer scanner 301 is operative to emit the light beam 122 toward the edge of a wafer, which may be stored in a wafer cassette. For example, the optical wafer scanner 301 may be employed to map a plurality of wafers (i.e., to detect the presence or absence of wafers) stored in the wafer cassette based on whether or not the emitted light beam 122 is received by the detector fiber 302b.

FIG. 3b depicts a detailed view of the proximal end of the wafer edge gripping end effector 100. As shown in FIG. 3b, the proximal end of the end effector 100 includes a second through-beam type optical wafer scanner 310 including third and fourth optical fibers 320a-320b. The third optical fiber 320a (shown in phantom) is configured to emit a light beam 322, and the fourth optical fiber 320b is configured to detect the light beam 322. As shown in FIG. 3b, the optical fiber 320a is disposed within the sub-assembly at the proximal end of the end effector 100 and is configured to emit the light beam 322 through an opening in the sub-assembly housing. Further, the optical fiber 320b is disposed in a channel formed in the paddle substrate 102. Those of ordinary skill in this art will appreciate that optical components for generating and for detecting the light beam 322 may be operatively coupled to the optical fibers 320a-320b, and that such optical components may be housed within the sub-assembly at the proximal end of the end effector 100. In the presently disclosed embodiment, the optical wafer scanner 310 including the emitter and detector fibers 320a-320b is employed in conjunction with the above-described mechanism for sensing the position of the wafer gripper 110 to provide enhanced detection of the presence of a wafer on the paddle substrate 102. The optical wafer scanner 310 is operative to emit the light beam 322 toward the edge of a wafer engaged by the wafer contact pads 105 and 108. For example, the optical wafer scanner 310 may be employed to detect a broken or severely mis-aligned wafer based on whether or not the emitted light beam 322 is received by the detector fiber 320b.

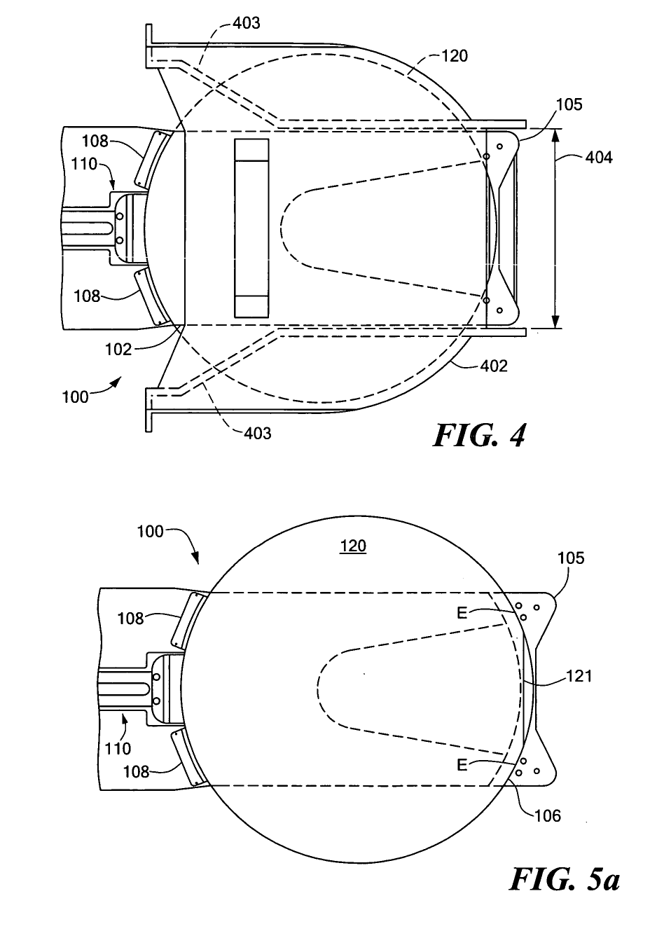

The embodiments disclosed herein will be better understood with reference to the following illustrative examples. As described above, when semiconductor wafers are stored in a wafer cassette, the wafers are generally supported along their edges by molded-in support structures on the inner walls of the cassette. FIG. 4 depicts a first illustrative example in which the wafer edge gripping end effector 100 is employed to load or unload the semiconductor wafer 120 into or out of a wafer cassette 402. As shown in FIG. 4, the wafer cassette 402 includes an internal support structure 403 that defines an opening through which the end effector 100 must pass. For example, the wafer cassette 402 may comprise a standard 200 mm wafer cassette, and the opening defined by the support structure 403 may be about 4.35 inches wide. In this first example, the end effector 100 is configured to load/unload the wafer 120 into/out of the wafer cassette 402 while providing sufficient clearance for the paddle substrate 102 and the wafer contact pad 105 to pass through the opening defined by the internal support structure 403.

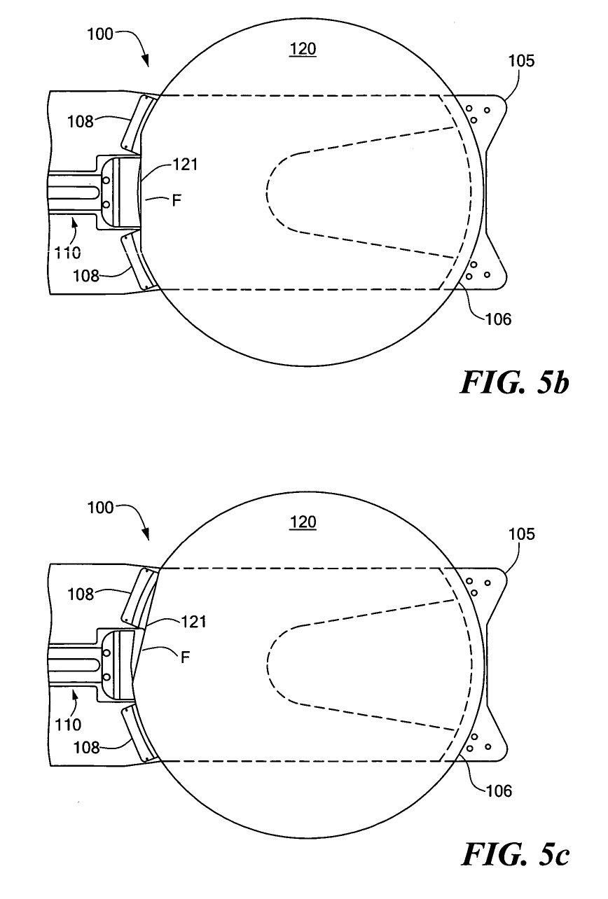

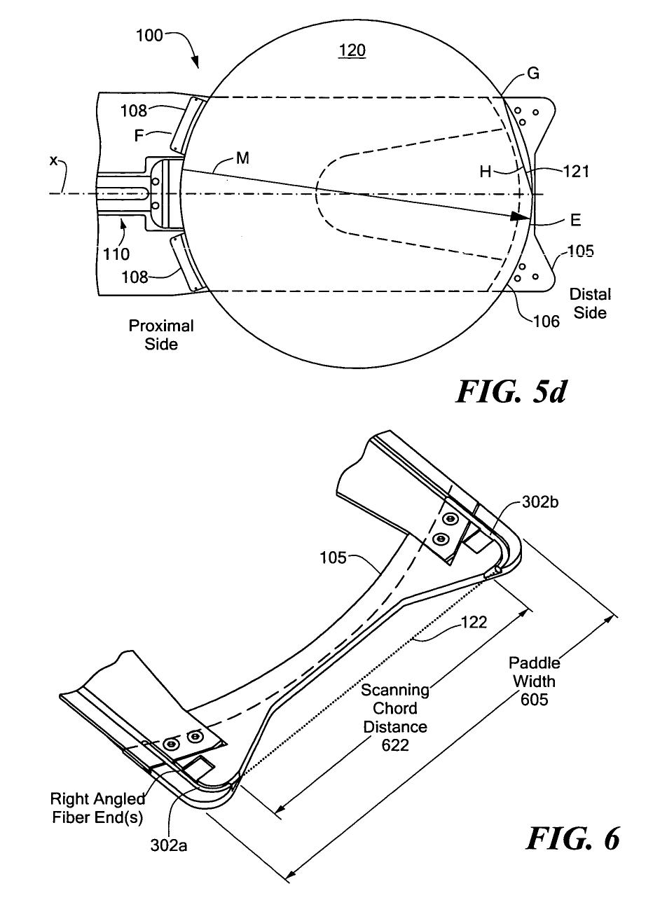

In a second illustrative example, FIGS. 5a-5d depict how the wafer edge gripping end effector 100 is employed to grip the semiconductor wafer 120 having the flat 121 formed in the wafer's edge. In this second example, the arcuate wafer gripper 110 is configured to apply forces to the wafer 120 that are substantially radial in nature. Such radial forces prevent the wafer 120 from being de- centered as the end effector 100 transitions from the pre-gripped to the post-gripped state. Further, the wafer contact pad 105 is configured to provide sufficient radial wafer edge support no matter where the flat 121 is located on the wafer's edge.

As shown in FIG. 5a, a first orientation of the wafer 120 positions the flat 121 between the contact points of the wafer's edge and the wafer contact pad 105 (the “flat 0° position”). In the flat 0° position, the wafer contact pad 105 is configured to provide sufficient radial support of the wafer's edge at edge locations “E” on each side of the flat 121. As shown in FIG. 5b, a second orientation of the wafer 120 positions the flat 121 substantially opposite the wafer gripper 110 (the “flat 180° position”). In the flat 180° position, the wafer gripper 110 is configured to apply radial forces to edge location “F” within the flat 121 to prevent de-centering of the wafer 120. Further, the arcuate shape and width of the wafer gripper 110 minimizes the distance that the gripper 110 must move to push the wafer's edge against the backstop 106 of the wafer contact pad 105. As shown in FIG. 5a, the wafer contact pad 105 is configured to straddle the flat 121. For example, arcuate length of the wafer contact pad 105 may be equal to at least two times the length of the flat 121. As shown in FIG. 5b, the wafer gripper 110 is configured to make contact with the wafer's edge within the region of the flat 121.

As shown in FIG. 5c, a third orientation of the wafer 120 positions the flat 121 such that it contacts the wafer gripper 110 and one of the wafer contact pads 108. For example, this third orientation of the wafer 120 may be designated as the “flat 160° position”. In the flat 160° position, the radial forces generated by the wafer gripper 110 are applied to edge location “F” so as to prevent the wafer 120 from de-centering and to minimize the stress on the wafer's edge. As shown in FIG. 5d, a fourth orientation of the wafer 120 positions the flat 121 between the center of the wafer contact pad 105 (i.e., at the approximate intersection of the axis X and the pad 105) and one end of the pad 105. For example, this fourth orientation of the wafer 120 may be designated the “flat 20° position”. In the flat 20° position, the wafer contact pad 105 is configured to provide sufficient radial support of the wafer's edge at edge locations “G” and “E” on each side of the flat 121. Specifically, the wafer gripper 110 contacts the proximal edge of the wafer 120 along the entire arcuate length of the gripper 110. Such contact of the wafer gripper 110 along the proximal edge of the wafer 120 above the axis X generates a force vector “M” directed toward edge location “E”, as depicted in FIG. 5d, thereby assuring that the wafer 120 is held along its curved edge and not within the region of the flat 121 between edge locations “G” and “H”.

In a third illustrative example, the scanning chord distance 622 (see FIG. 6) defined by the optical fibers 302a-302b included in the optical wafer scanner 301 (see FIG. 3a) is maximized to allow optimal mapping of flatted wafers. The optical fibers 302a-302b comprise small radius right angled stainless steel fiber ends disposed in respective channels formed in the wafer contact pad 105 (see FIGS. 3a and 6). The small radii of the optical fibers 302a-302b allow the scanning chord distance 622 to be maximized within the limited width 605 (e.g., less than 4.35 inches; see FIG. 6) of the paddle substrate 102.

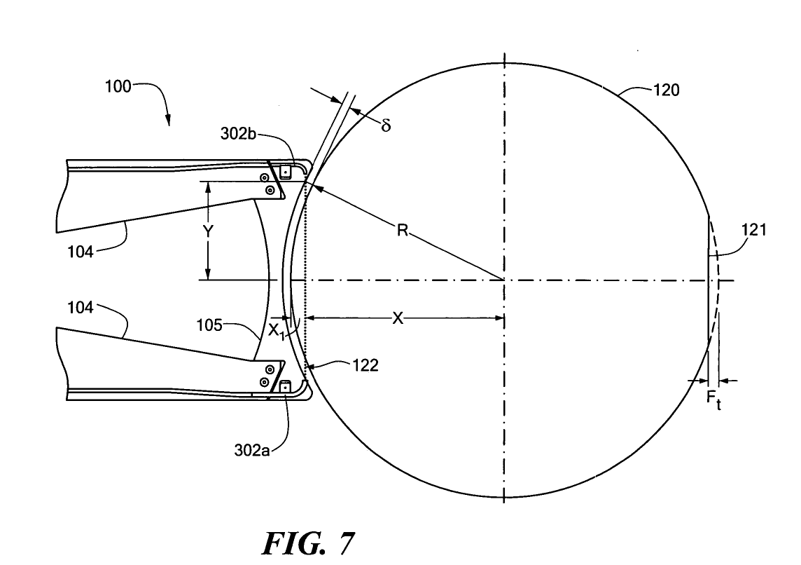

In this third example, representative parameters associated with the end effector 100 and the wafer 120 including the flat 121 are defined as
R=3.937 inches, (1)
Y=1.773 inches, (2)
δ=0.150 inches (3)
in which “R” is the radius of the wafer 120, “Y” is the distance from the centerline of the wafer 120 to the edge of the optical fiber 302b, and “δ” is the clearance from the wafer 120 to the wafer contact pad 105 (see FIG. 7). FIG. 7 also illustrates a representative parameter “X”, which is the distance from the center of the wafer 120 to the normal unobstructed path of the light beam 122, and a representative parameter “X₁”, which is the distance from the edge of the wafer 120 to the unobstructed path of the light beam 122. For example, X may be expressed as
X=\sqrt{(R+δ)²−Y²}, (4)
and x₁ may be expressed as
X₁=R−X. (5)
Substituting the values for R, δ, and Y indicated in equations (1)-(3) into equation (4) above yields
X=3.682 inches, (6)
and substituting the values for R and X indicated in equations (1) and (6) into equation (5) above yields
X₁=0.255 inches. (7)

In this third example, another representative parameter called the chord tangent margin “Cₜₘ” is defined as
Cₜₘ=X₁−Fₜ, (8)
in which “Fₜ” is the depth of the flat 121 (see FIG. 7). For example, Fₜ may be equal to about 0.177 inches. Substituting this value for Fₜ and the value for X₁ indicated in equation (7) into equation (8) above yields
Cₜₘ=0.078. (9)

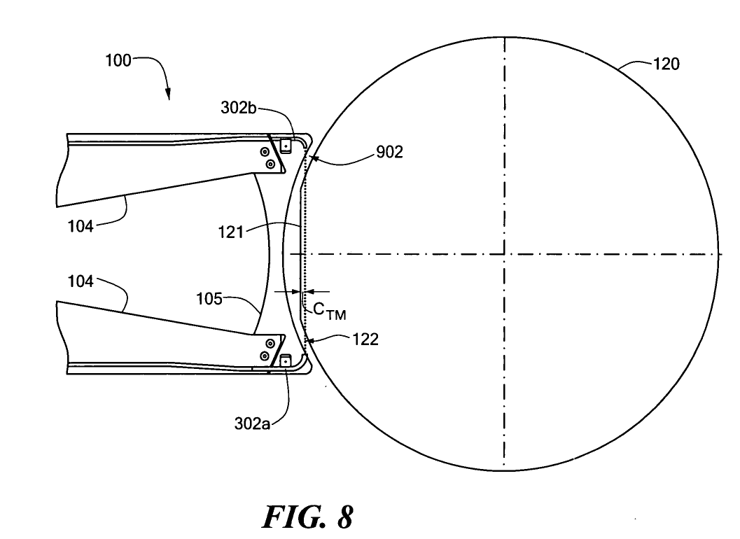

As shown in FIG. 8, for the representative values of the parameters R, Y, δ, Fₜ, and Cₜₘ indicated above, the wafer 120 with the flat 121 facing the end effector 100 obstructs the path of the light beam 122 generated by the optical wafer scanner 301. As shown in FIG. 7, the path of the light beam 122 is similarly obstructed by the wafer 120 when the flat 121 does not face the end effector 100. As a result, the optical wafer scanner 301 can successfully detect and map the wafer 120 when the flat 121 faces away from the end effector 100, as indicated in FIG. 7, and when the flat 121 faces the end effector 100, as indicated in FIG. 8.

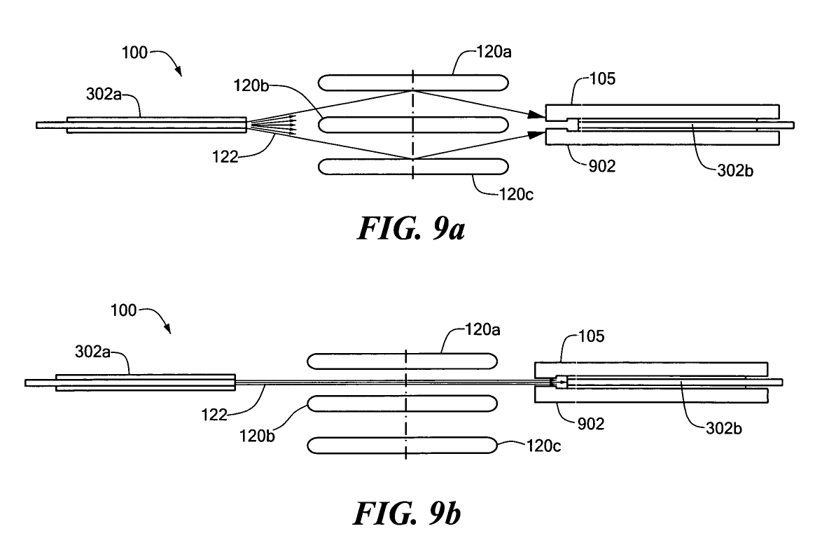

In a fourth illustrative example, the optical wafer scanner 301 included in the wafer edge gripping end effector 100 is again employed to map a plurality of semiconductor wafers, namely, wafers 120a-120c (see FIGS. 9a-9b). Specifically, the optical fiber 302a is operative to emit the light beam 122, and the optical fiber 302b is operative to detect the light beam 122. As shown in FIG. 9a, the end effector 100 is positioned such that the path of the light beam 122 is obstructed by the wafer 120b, thereby causing stray light beams to reflect from respective surfaces of the wafers 120a and 120c toward the detector fiber 302b. In this fourth example, the wafer contact pad 105 includes a baffle portion 902, which is configured to prevent the stray light beams reflected by the wafers 120a and 120c from impinging upon and being detected by the detector fiber 302b. Because the baffle 902 prevents such stray light from being detected by the optical fiber 302b, the optical wafer scanner 301 can detect the presence of the wafer 120b with increased reliability. As shown in FIG. 9b, when the end effector 100 is positioned such that no wafer obstructs the path of the light beam 122, the baffle 902 allows the light beam 122 to be detected by the detector fiber 302b.

FIGS. 10a-10c depict the linear actuator 112 included in the above-described effector mechanism for moving the wafer gripper 110 (see also FIG. 1). As shown in FIGS. 10a-10b, the linear actuator 112 includes the bellows 1001, the sealed first end 1002, and the second end 1004 including the port 1006. The bellows 1001 is configured to provide a housing for a linear bearing rod 1010, and a sleeve bearing 1008 for guiding the linear bearing rod 1010. In the preferred embodiment, the bellows 1001 is metallic, and the mechanism comprising the sleeve bearing 1008 and the linear bearing rod 1010 is actuated with a vacuum. Specifically, the vacuum is created within the bellows housing via the port 1006, thereby retracting the bellows 1001 and causing the linear bearing rod 1010 to move within the sleeve bearing 1008 toward the second end 1004. When the vacuum is released via the port 1006, the bellows 1001 expands, thereby causing the linear bearing rod 1010 to move within the sleeve bearing 1008 away from the second end 1004. The mechanism including the sleeve bearing 1008 and the linear bearing rod 1010 is self-contained and sealed within the bellows housing to prevent the emission of particles that may contaminate a semiconductor wafer.

It will be appreciated by those of ordinary skill in the art that further modifications to and variations of the above-described 200 mm notched/flatted wafer edge gripping end effector may be made without departing from the inventive concepts disclosed herein. Accordingly, the invention should not be viewed as limited except as by the scope and spirit of the appended claims.

1. A wafer edge gripping end effector, comprising:
a paddle substrate having a distal end and a proximal end;
a first arcuate wafer contact pad disposed on the paddle substrate at the distal end;
second and third wafer contact pads disposed on the paddle substrate adjacent the proximal end,
wherein each one of the first, second, and third wafer contact pads includes a first surface and a second beveled surface, the respective first and second surfaces of the first, second, and third wafer contact pads being configured to engage a circumferential edge of a wafer; and
a movable wafer gripping finger disposed on the paddle substrate between the second and third wafer contact pads adjacent the proximal end, the movable finger having a first arcuate surface configured to contact the edge of the wafer,
wherein the movable finger is operative to move toward the distal end of the paddle substrate, to contact the edge of the wafer by the first surface thereof, and to push the edge of the wafer against the first surface of the first wafer contact pad, thereby securing the wafer engaged by the first, second, and third wafer contact pads.

2. The wafer edge gripping end effector of claim 1 wherein the edge of the wafer includes a flat region, and wherein the first surface of the first wafer contact pad is an arcuate surface configured to straddle the flat region of the wafer.

3. The wafer edge gripping end effector of claim 1 wherein the edge of the wafer includes a flat region, and wherein the movable finger is configured to allow the first arcuate surface thereof to straddle at least a portion of the edge of the wafer within the flat region.

4. The wafer edge gripping end effector of claim 1 wherein the paddle substrate comprises first and second fixed fingers, and wherein the first wafer contact pad is disposed between the first and second fixed fingers.

5. The wafer edge gripping end effector of claim 1 further including first and second optical fibers disposed at the distal end of the substrate, the first fiber being operative to emit a light beam, the second fiber being operative to receive the light beam, further including a mechanism configured to generate the light beam emitted by the first fiber and to detect the light beam received by the second fiber, and wherein the first and second fibers and the light beam generation and detection mechanism are operative to detect the presence of a wafer.

6. The wafer edge gripping end effector of claim 5 further including a baffle configured to allow the second fiber to receive only light beams that directly impinge thereon.

7. The wafer edge gripping end effector of claim 1 further including a mechanism configured to sense a position of the movable finger.

8. The wafer edge gripping end effector of claim 1 further including first and second optical fibers disposed adjacent the proximal end of the substrate, the first fiber being operative to emit a light beam, the second fiber being operative to receive the light beam, further including a mechanism configured to generate the light beam emitted by the first fiber and to detect the light beam received by the second fiber, and wherein the first and second fibers and the light beam generation and detection mechanism are operative to detect the presence of a wafer engaged by the first, second, and third wafer contact pads.

9. The wafer edge gripping end effector of claim 1 further including a mechanism configured to move the movable finger, the mechanism comprising a linear actuator including an expandable and retractable bellows housing, the linear actuator further including a linear bearing rod and a sleeve bearing configured to guide the linear bearing rod, the linear bearing rod and the sleeve bearing being disposed within the bellows housing, and wherein the movable finger is operative to move based on the expansion and the retraction of the bellows housing.

10. The wafer edge gripping end effector of claim 9 wherein the bellows housing is sealed to prevent emission of wafer contaminants.

11. A method of operating a wafer edge gripping end effector, comprising the steps of:
providing a paddle substrate having a distal end and a proximal end;
providing a first arcuate wafer contact pad disposed on the paddle substrate at the distal end;
providing second and third wafer contact pads disposed on the paddle substrate adjacent the proximal end,
wherein each one of the first, second, and third wafer contact pads includes a first surface and a second beveled surface, the respective first and second surfaces of the first, second, and third wafer contact pads being configured to engage a circumferential edge of a wafer;
providing a movable wafer gripping finger disposed on the paddle substrate between the second and third wafer contact pads adjacent the proximal end, the movable finger having a first arcuate surface configured to contact the edge of the wafer;
moving the movable finger toward the distal end of the paddle substrate;
contacting the edge of the wafer by the first surface of the movable finger; and
pushing the edge of the wafer against the first surface of the first wafer contact pad by the first surface of the movable finger, thereby securing the wafer engaged by the first, second, and third wafer contact pads.

12. The method of claim 11 wherein the edge of the wafer includes a flat region, wherein the first surface of the first wafer contact pad is an arcuate surface, and further including the step of straddling the flat region of the wafer by the first arcuate surface of the first wafer contact pad.

13. The method of claim 11 wherein the edge of the wafer includes a flat region, and further including the step of straddling at least a portion of the edge of the wafer within the flat region by the first arcuate surface of the movable finger.

14. The method of claim 11 wherein the paddle substrate comprises first and second fixed fingers, and wherein the first wafer contact pad is disposed between the first and second fixed fingers.

15. The method of claim 11 further including the steps of emitting a light beam, receiving the light beam, detecting the light beam, and detecting the presence of a wafer by the detecting step.

16. The method of claim 15 wherein the receiving step includes providing a light receiver for receiving the light beam, and further including the step of allowing the light receiver to receive only light beams that directly impinge thereon.

17. The method of claim 11 further including the step of sensing a position of the movable finger.

18. The method of claim 11 further including the steps of providing first and second optical fibers disposed adjacent the proximal end of the substrate, the first fiber being operative to emit a light beam, the second fiber being operative to receive the light beam, providing a mechanism for generating the light beam emitted by the first fiber and for detecting the light beam received by the second fiber, and detecting the presence of a wafer engaged by the first, second, and third wafer contact pads by the first and second fibers and the light beam generation and detection mechanism.

19. The method of claim 11 further including the step of providing a mechanism for moving the movable finger, the mechanism comprising a linear actuator including an expandable and retractable bellows housing, the linear actuator further including a linear bearing rod and a sleeve bearing configured to guide the linear bearing rod, the linear bearing rod and the sleeve bearing being disposed within the bellows housing, and wherein the movable finger is operative to move based on the expansion and the retraction of the bellows housing.

20. The method of claim 19 wherein the bellows housing is sealed to prevent emission of wafer contaminants.
